(19) United States
(12) Patent Application Publication
(10) Pub. No.: US 2025/0320613 A1
(43) Pub. Date: Oct. 16, 2025

(54) Reactor For Producing Hydrogen From Water

(71) Applicants: George J. Coates, Wall Township, NJ (US); Gregory Coates, Wall Township, NJ (US)

(72) Inventors: George J. Coates, Wall Township, NJ (US); Gregory Coates, Wall Township, NJ (US)

(21) Appl. No.: 19/173,194

(22) Filed: Apr. 8, 2025

Related U.S. Application Data
(60) Provisional application No. 63/632,583, filed on Apr. 11, 2024.

(51) Int. Cl. C25B 1/50; C25B 1/04; C25B 9/17; C25B 9/60

(52) U.S. Cl. CPC C25B 1/50; C25B 1/04; C25B 9/17; C25B 9/60

(57) ABSTRACT

A reactor for producing hydrogen from water by applying a magnetic field and positive and negative electric charges to the water, and by heating the water with a hot gas. The reactor comprises a housing, at least one conduit for supplying water to the housing, at least one magnetic inductor for applying a magnetic field to the water, electrode plates for applying positive and negative charges to the water, and a conduit for supplying a hot gas to the housing. The reactor also includes a conduit for removing the hydrogen from the housing. The hydrogen produced by the reactor may be supplied as at least a portion of the fuel required to power or run generators that provide electric power to substations, dams, or buildings, or engines in vehicles such as cars, trucks, buses, boats, ships, locomotives, motorcycles, airplanes, submarines, golf carts, lawn mowers, and Zambonis.

This application claims priority based on provisional application Ser. No. 63/632,583, the contents of which are incorporated by reference in their entirety.

This invention relates to reactors for producing hydrogen. More particularly, this invention relates to a reactor for producing hydrogen from water through the application of a magnetic field, and positive and negative charges such as, for example, positive and negative direct current charges, to the water, and heating the water.

Generators and engines are used to supply power for a variety of vehicles, buildings, and other structures, including, but not limited to, generators which provide power to electric power substations, dams, and buildings, such as houses, office buildings, schools, stores, hotels, motels, churches, arenas, stadiums, and hospitals, as well as engines in automobiles, trucks, buses, locomotives, airplanes, ships, boats, submarines, motorcycles, golf carts, lawn mowers, Zambonis, and the like. Such generators and engines require fuel in order to operate. Examples of fuel include, but are not limited to, gasoline, diesel fuel, oil, and natural gas. Depending upon the type of generator or engine, significant amounts of the above-mentioned fuels may be required.

The amount of the above-mentioned fuels required for the above-mentioned engines or generators could be reduced if hydrogen, and in particular gaseous hydrogen, is added to such fuels. The addition of hydrogen also would reduce the amount of pollutants produced by the burning and consumption of such fuels.

It therefore is an object of the present invention to provide an efficient means for generating hydrogen which then can be used in combination with other fuels for providing power to engines and generators, whereby the amounts of fuels such as gasoline, diesel, oil, and natural gas, and the gaseous emissions from such fuels, are reduced.

In accordance with an aspect of the present invention, there is provided a reactor for producing hydrogen. The reactor comprises a housing, and at least one conduit for supplying water to the housing. At least one magnetic inductor is contained in the housing. The at least one magnetic inductor applies a magnetic field to the water in the housing.

At least two electrode plates are contained in the housing. The at least two electrode plates are capable of applying an electric charge to the water in the housing. Each of the at least two electrode plates, when supplied with an electric current by a source of electric current, has a positive charge or a negative charge. The number of electrode plates having a positive charge equals the number of electrode plates having a negative charge, when the at least two electrode plates are supplied with an electric current by a source of electric current.

In a non-limiting embodiment, the reactor contains 26 positively charged electrode plates and 26 negatively charged electrode plates, when the plates are supplied with an electric current, which are spaced alternately in the reactor. The positively charged and negatively charged plates are spaced at a sufficient distance from each other by spacer rods. One set of spacer rods is attached to the positively charged plates, and another set of spacer rods is attached to the negatively charged plates. In a non-limiting embodiment, a spacer is attached to each plate to aid further in spacing the plates at a proper distance from each other.

The reactor further includes at least one conduit supplying a hot gas to the housing. Upon induction of the magnetic field by the at least one magnetic inductor to the water in the housing, upon application of an electric charge to the water in the housing, and upon heating of the water in the housing by the hot gas, hydrogen is produced from the water. The hydrogen is withdrawn from the housing through at least one conduit.

Although the scope of the present invention is not to be limited to any theoretical reasoning, it is believed that applying a combination of a magnetic field, an electrical charge, and heat to water, provides an efficient generation of hydrogen from the water. More particularly, the at least one magnetic inductor, which applies a magnetic field to the water, arranges the water molecules in such a manner that the water molecules become more conducive to being split into hydrogen and oxygen. The application of the electrical charge and heat to the water then splits the water molecules into hydrogen and oxygen. The hydrogen then may be used as fuel for generators or motors, in combination with other fuels such as gasoline, diesel fuel, oil, and natural gas, thereby providing for reduced consumption of gasoline, diesel fuel, oil, or natural gas by such generators or engines, and providing for reduced emissions of gases such as carbon monoxide, carbon dioxide, hydrocarbons, and nitrogen oxides.

More particularly, the water may, in a non-limiting embodiment, contain salt (NaCl) that is dissolved in the water. The salt splits into sodium ions and chlorine ions in the water. Thus, the water in the reactor is an electrolyte. The application of a magnetic field to the water in the reactor relaxes or loosens the covalent bonds of the water molecules. The heat that is supplied by the hot gas loosens the covalent bonds of the water molecules further. The application of the electric charge through a direct current from the electrode plates then splits the water into hydrogen and oxygen, which then will be removed from the reactor.

In a non-limiting embodiment, the reactor comprises at least two conduits for supplying water to the housing.

In another non-limiting embodiment, the reactor comprises at least two magnetic inductors in said housing. In yet another non-limiting embodiment, the reactor comprises four magnetic inductors in the housing.

In a non-limiting embodiment, each of the at least one magnetic inductor(s) comprises two semi-cylindrical halves, wherein each half has a longitudinal channel such that when the two semi-cylindrical halves are juxtaposed, there is defined a cylinder. Each semi-cylindrical half has a plurality of permanent magnets positioned therein.

In a non-limiting embodiment, the cylinder formed from the juxtaposed cylindrical halves is capable of receiving a water conduit, and the cylinder forms an annular ring permanent magnet. In an alternative non-limiting embodiment, the cylinder that forms the annular ring permanent magnet, also serves as a water conduit. Non-limiting examples of magnetic inductors which may be employed in the present invention are described in U.S. Pat. No. 6,008,710, the contents of which are incorporated by reference.

In a non-limiting embodiment, the at least one magnetic inductor(s) apply/applies a magnetic field having a strength of about 13,000 Gauss.

In a non-limiting embodiment, the at least one conduit for supplying a hot gas to the housing supplies the hot gas such that it heats the water to a temperature of from about 50° F. to about 400° F. In another non-limiting embodiment, the hot gas heats the water to a temperature of about 120° F.

In another non-limiting embodiment, the reactor further comprises at least one pump connected operatively to the at least one conduit for supplying water to the housing, whereby the water is delivered from the conduit to the housing. In a non-limiting embodiment, the water is kept at a level above the electrode plates.

Once the hydrogen is produced by the reactor, the hydrogen then may be used as a fuel to supply at least a portion of the fuel requirements of generators or engines that supply power for a variety of vehicles, buildings, and other structures such as those hereinabove described. By supplying hydrogen as a fuel for such generators or engines, the reactor reduces the requirements of other fuels, such as gasoline, diesel fuel, oil, and natural gas, that are used for such generators or engines, and thereby reducing the emissions produced by the burning of such other fuels.

The hydrogen, in a non-limiting embodiment, is withdrawn from the reactor and fed directly to the generator or engine in which it will be used as a fuel. In an alternative non-limiting embodiment, the hydrogen is withdrawn from the reactor and passed to a holding tank or expansion tank, from which the hydrogen may be fed, as desired or needed, to the generator or engine in which the hydrogen is being used as a fuel. The pressure of the hydrogen in the holding tank or expansion tank may be monitored, and if the pressure of the hydrogen in the holding tank or expansion tank exceeds a predetermined amount, a portion of the hydrogen can be recycled to the reactor.

The present invention provides for the generation of increased amounts of hydrogen from water. Thus, in accordance with another aspect of the present invention, there is provided a method of producing hydrogen from water. The method comprises introducing water into a reactor. A magnetic field is applied to the water in the reactor, and a positive electric charge and a negative electric charge also are applied to the water in the reactor. A hot gas is introduced into the reactor. Upon applying a magnetic field to the water in the reactor, upon applying the positive and negative electric charges to the water in the reactor, and upon heating the water by the hot gas, hydrogen is produced from the water. The hydrogen then is recovered from the reactor.

As noted hereinabove, in a non-limiting embodiment, the magnetic field is applied to the water at a strength of about 13,000 Gauss.

In another non-limiting embodiment, the electrode plates are operated at a wattage of about 2,500 watts, or 2.5 kW, thereby applying the positive and negative electric charges to the water at a wattage of about 2,500 watts, or 2.5 kW.

In another non-limiting embodiment, the water is heated by the hot gas to a temperature of from about 50° F. to about 400° F. In a further non-limiting embodiment, the water is heated by the hot gas to a temperature of about 120° F.

The invention now will be described with respect to the drawings, wherein:

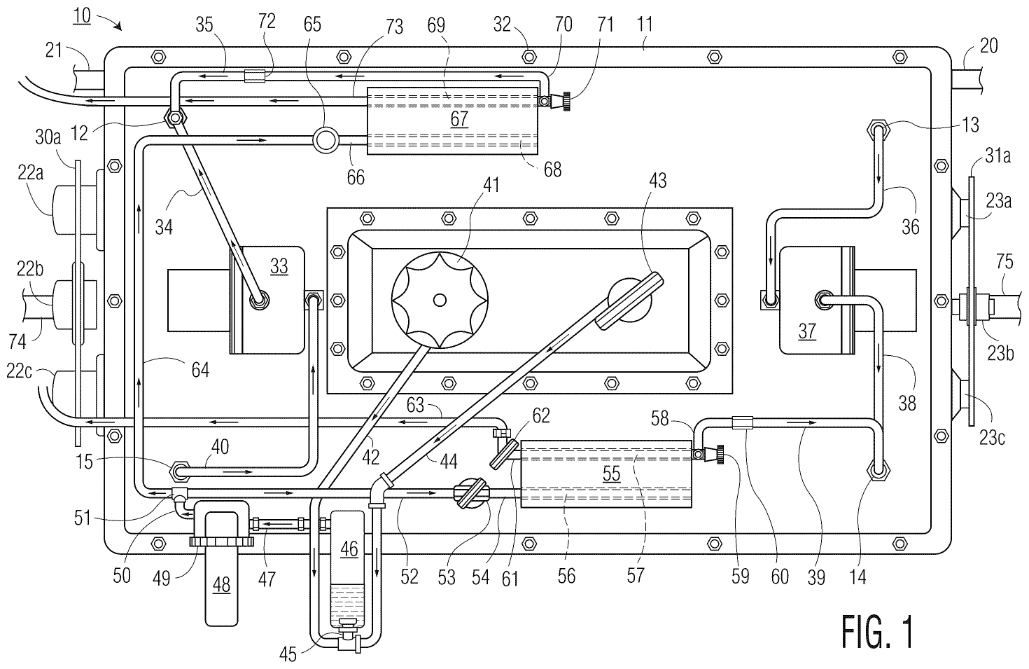

FIG. 1 is a top perspective and schematic view of an embodiment of the reactor of the present invention;

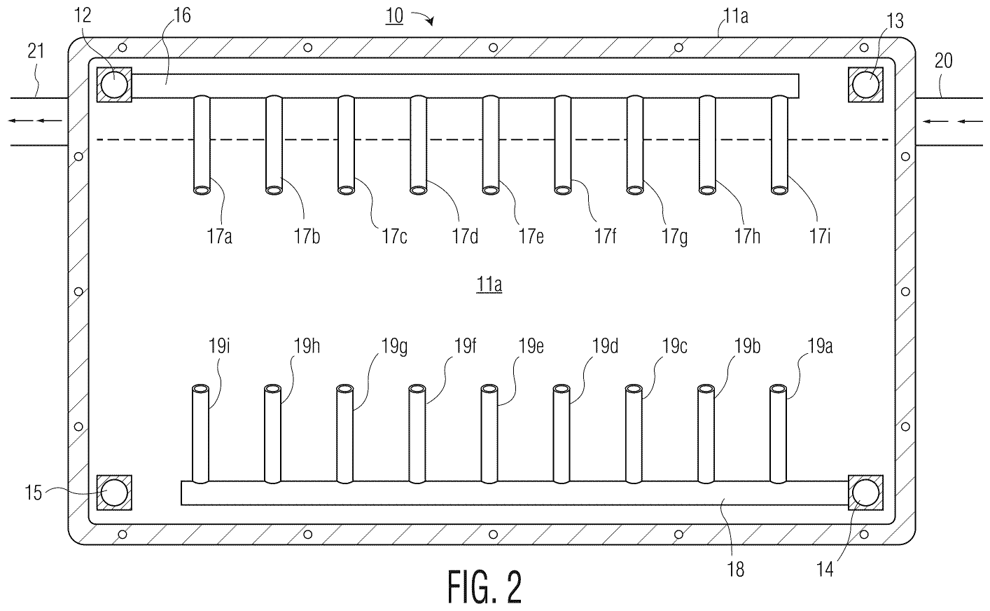

FIG. 2 is a cross-sectional view of the interior of the bottom portion of the reactor shown in FIG. 1;

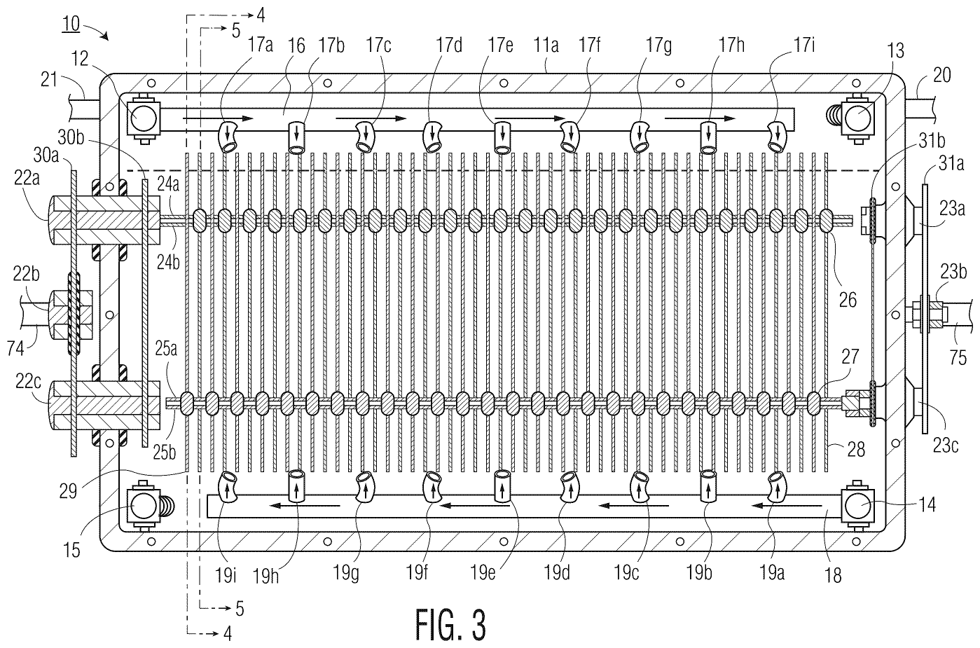

FIG. 3 is a cross-sectional view of the interior of the reactor shown in FIG. 1 above the electrode plates;

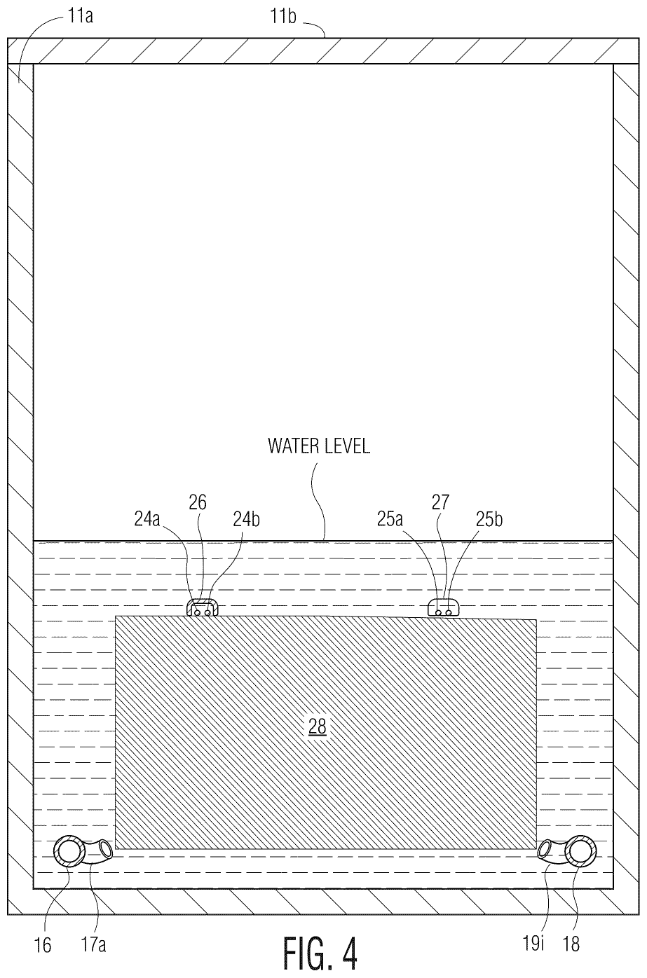

FIG. 4 is a cross-sectional view of a positive electrode plate contained in the reactor;

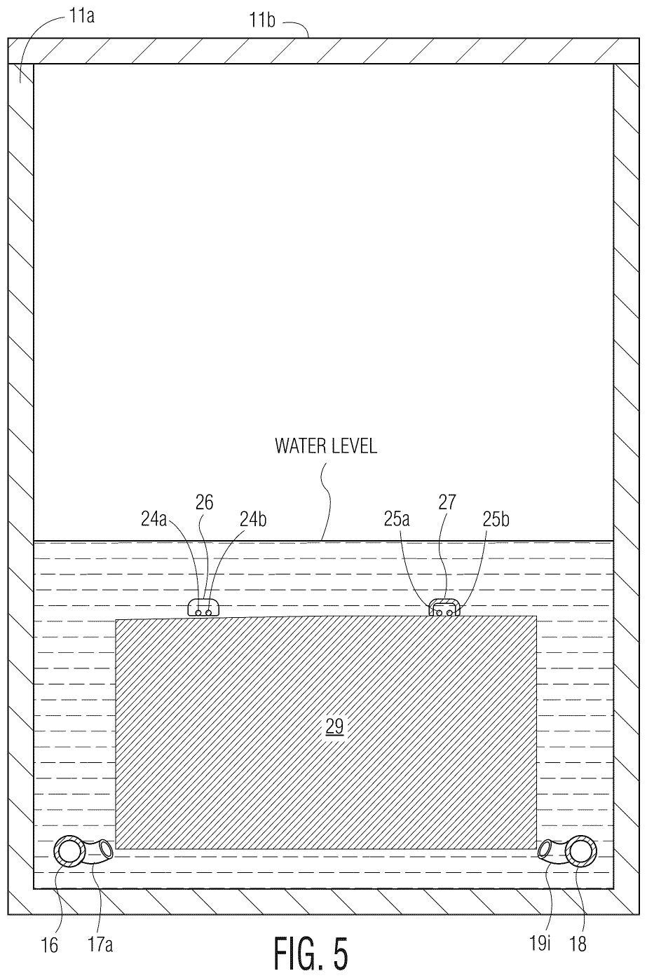

FIG. 5 is a cross-sectional view of a negative electrode plate contained in the reactor;

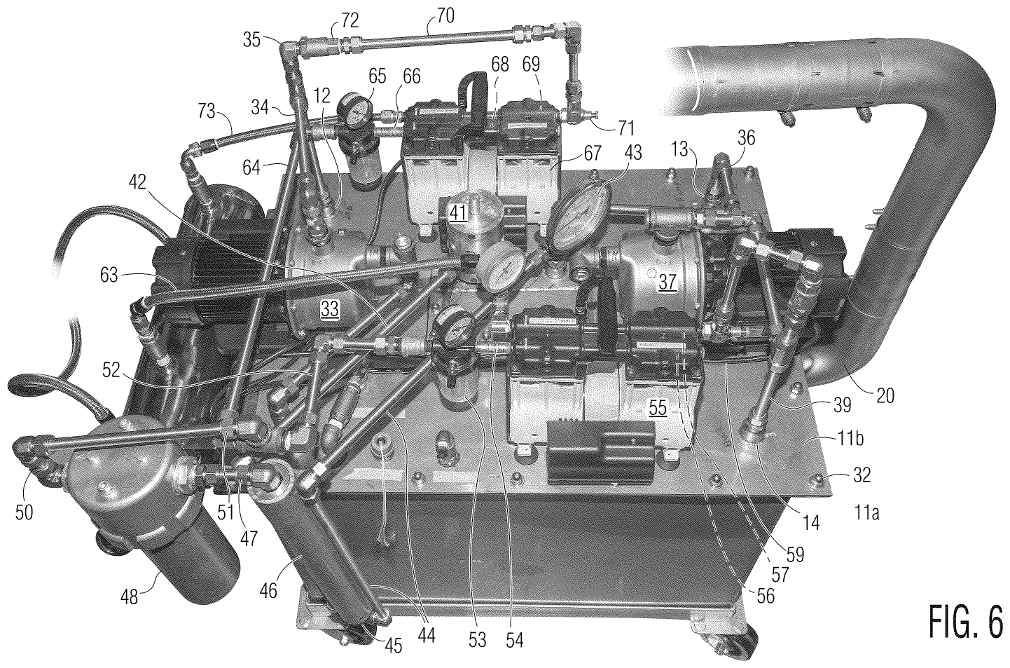

FIG. 6 is a photograph of a top perspective view of the reactor shown in FIG. 1;

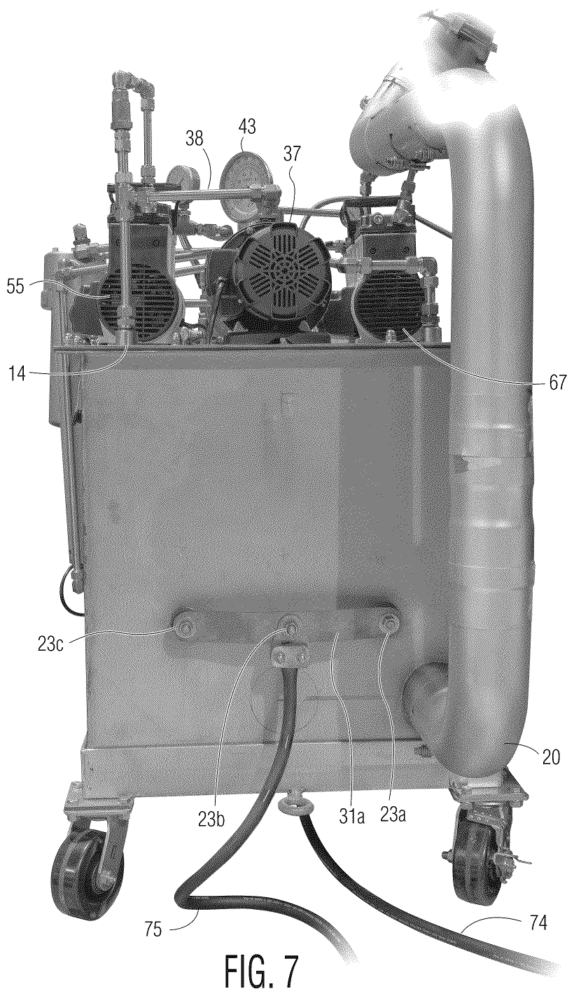

FIG. 7 is a photograph of a side view of the reactor shown in FIGS. 1 and 6;

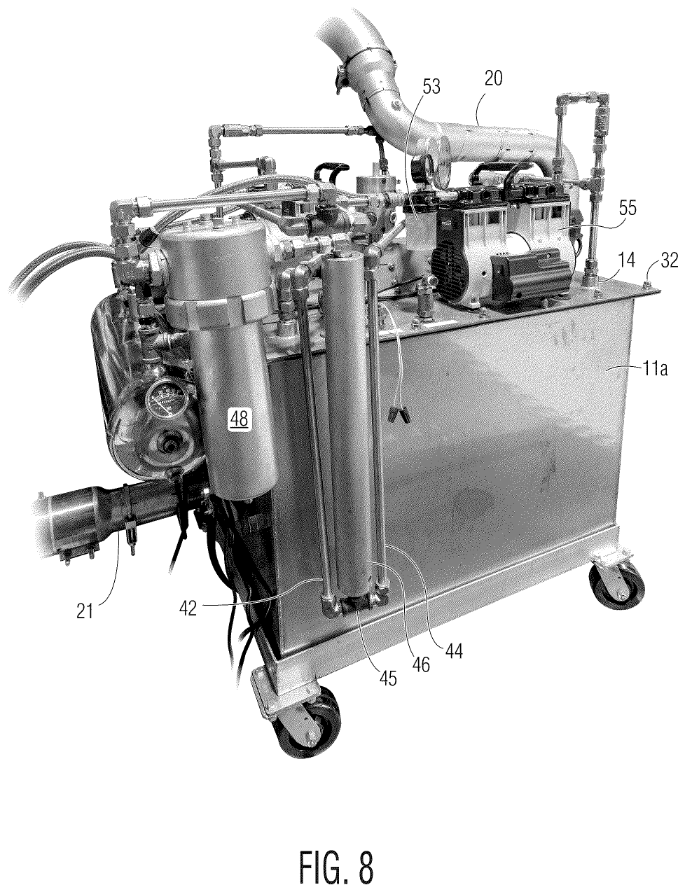

FIG. 8 is a photograph of a front and side perspective view of the reactor; and

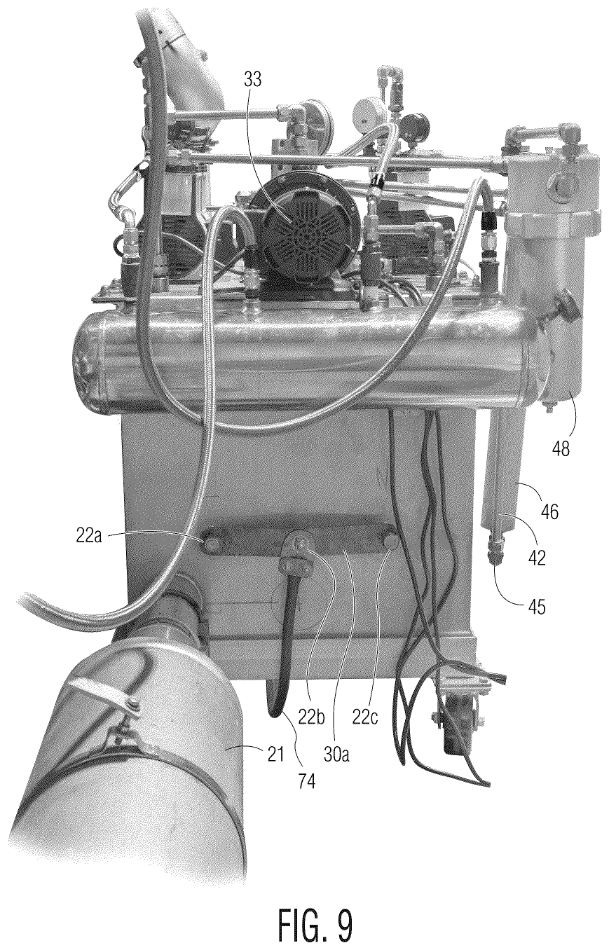

FIG. 9 is a photograph of another side view of the reactor shown in FIGS. 1 and 6.

Referring now to the drawings, a non-limiting embodiment of a reactor 10 in accordance with the present invention includes a housing 11, and magnetic inductors 12, 13, 14, and 15, each of which is capable of receiving a conduit, or is capable of acting itself as a conduit for conducting or transporting water, vertically through housing 11. Inductors/conduits 12 and 14 transport water, either alone or in combination with a gas such as hydrogen gas, into housing 11. Inductors/conduits 13 and 15 remove water from housing 11. Housing 11 includes a container portion 11a and a cover portion 11b. Cover portion 11b is attached to container portion 11a by bolts 32. As noted hereinabove, each of magnetic inductors 12, 13, 14, and 15 may be in the form of a cylinder which contains a plurality of permanent magnets (not shown) positioned therein, whereby each of magnetic inductors 12, 13, 14, and 15 acts as an annular ring permanent magnet.

Extending horizontally from magnetic inductor/conduit 12 near the floor of housing 11 is conduit 16, from which extend a series of jets 17a through 17i. Extending horizontally from magnetic inductor/conduit 14 near the floor of housing 11 is conduit 18, from which extend a plurality of jets 19a through 19i. Jets 17a through 17i and jets 19a through 19i also act as an excitation system for dislodging atoms, especially hydrogen atoms, from electrode plates 28 and 29.

Inlet 20 delivers a hot gas, such as heated exhaust gas, from an engine or generator which is being supplied with hydrogen produced by reactor 10, into housing 11. The hot gas heats the water in housing 11. The temperature of the water that is heated by the hot gas is monitored by temperature gauge 43. Alternatively, the gas may be fresh gas. In a non-limiting embodiment, the gas is a hot gas which may be at a temperature of about 700° F., and which heats the water to a temperature of from about 50° F. to about 400° F. The hot gas is withdrawn from the housing 11 through outlet 21.

As water passes through and enters housing 11 through magnetic inductors/conduits 12 and 14, and then through conduits 16 or 18, and then through jets 17a through 17i, or through jets 19a through 19i, a magnetic field is supplied to the water by magnetic inductors/conduits 12, 13, 14, and 15. As the water enters the housing 11, the water contacts positively charged electrode plates 28 and negatively charged electrode plates 29, and rises to a level in housing 11 that is above the tops of the electrode plates 28 and 29. As shown in the drawings, there are 26 positively charged electrode plates, referred to collectively as 28, and 26 negatively charged electrode plates, referred to collectively as 29. It is to be understood that the scope of the present invention is not to be limited to any specific number of positively charged electrode plates, and negatively charged electrode plates, as long as the number of positively charged electrode plates equals the number of negatively charged electrode plates. The positively charged electrode plates 28 are held in place by rods 24a and 24b and spacers 26. The negatively charged electrode plates 29 are held in place by rods 25a and 25b and spacers 27. Attached to the housing 11 are positively charged poles 22a. 22b, and 22c, which are held in place by plates 30a and 30b, and negatively charged poles 23a, 23b, and 23c, which are held in place by plates 31a and 31b. Rods 24a and 24b are attached to pole 22a, and rods 25a and 25b are attached to pole 23c. Power cord 74 supplies electric current from a power source, such as an electrical socket (not shown) to positively charged poles 22a, 22b, and 22c, and power cord 75 supplies electric current from a power source, such as an electric socket (not shown), to negatively charged poles 23a, 23b, and 23c. The positive charge then is supplied from poles 22a, 22b, and 22c through rods 24a and 24b to the positively charged electrode plates 28. The negative charge then is supplied from poles 23a, 23b, and 23c through rods 25a and 25b to the negatively charged electrode plates 29. The positive and negative electric charges, in a non-limiting embodiment, are supplied to the electrode plates at a wattage of about 2,500 watts, or 2.5 kW. In another non-limiting embodiment, the positive and negative electrical charges are supplied to the electrode plates at an amperage of about 200 amps.

As the positive and negative charges are applied to the water by the positive electrode plates 28 and the negatively charged electrode plates 29, at least a portion of the water molecules are split into hydrogen and oxygen. As a result, some hydrogen atoms may be retained by the electrode plates 28 and 29. The water which is supplied to housing 11 by jets 17a through 17i and jets 19a through 19i dislodges hydrogen atoms which were retained by plates 28 and 29.

As the water enters the housing 11, and through the inductors/conduits 12 and 14, in which a magnetic field is applied, through conduits 16 and 18, and through jets 17a through 17i and jets 19a through 19i, and contacts the electrode plates 28 and 29, and is contacted with the hot gas, which may be an exhaust gas, from inlet 20, to heat the water, the combination of subjecting the water to a magnetic field, which is applied by inductors/conduits 12, 13, 14, and 15, and applying an electrical charge to the water, and heating the water, the water is separated into a mixture of hydrogen and oxygen known as HHO, also known as Brown's gas, or oxyhydrogen gas, or hydroxyl gas. After the hydrogen is produced, the hydrogen, oxygen, and remaining water are withdrawn from housing 11. A first portion of the remaining water is withdrawn from housing 11 through conduit 13, and then is passed to line 36, and then enters pump 37. The water then is pumped from pump 37 to line 38. A second portion of the water is withdrawn from housing 11 through conduit 15, and then is passed to line 40, and then enters pump 33. The water then is pumped from pump 33 to line 34.

Hydrogen and oxygen are withdrawn from the housing 11 through lines 42 and 44. A main blowback valve 41 regulates the flow and pressure of the hydrogen and oxygen in line 42, and prevents the flow of hydrogen back to housing 11, thereby preventing possible detonation of the hydrogen. The hydrogen and oxygen in lines 42 and 44 then are passed to blowback valve 45, which regulates the flow of the hydrogen and oxygen into a non-conductor blowback system 46, which contains oil. Blowback valve 45 also prevents the flow of hydrogen back to housing 11, thereby preventing possible detonation of the hydrogen. The hydrogen and oxygen then are withdrawn from the blowback system 46 through line 47 and passed to a hydrogen dryer 48 that contains a filter 49, whereby the hydrogen and oxygen are dried and filtered. The dried and filtered hydrogen and oxygen are withdrawn from the dryer 48 through line 50 and enter valve 51. A portion of the hydrogen and oxygen then is passed to line 52, and another portion is passed to line 64.

The hydrogen and oxygen in line 52 are passed through vacuum gauge and water trap 53, line 54, and into combined vacuum/pressurizer 55.

Vacuum/pressurizer 55 has a vacuum portion 56 and a pressurizing portion 57. The hydrogen and oxygen pass first through vacuum portion 56, whereby the hydrogen and oxygen are subjected to a vacuum. The hydrogen and oxygen then are passed to the pressurizing portion 57, whereby the hydrogen and oxygen are subjected to a pressure of from about 20 psi to about 40 psi. Once the hydrogen and oxygen are pressurized, a portion of the hydrogen and oxygen is withdrawn from the pressurizing portion 57 through hydrogen pressure adjuster 59, passed to line 58, then passed through check valve 60, and then passed to line 39. The hydrogen and oxygen in line 39 then are combined with water in line 38 and passed to conduit 14, whereby a magnetic field is applied to the water and hydrogen and oxygen, and whereby such water and hydrogen and oxygen are recycled to housing 11.

Another portion of the pressurized hydrogen and oxygen is withdrawn from the pressurizing portion 57 through line 61, and then is passed through pressure gauge 62 into line 63. Line 63 supplies hydrogen and oxygen as a fuel source for a generator or engine that is being powered. In a non-limiting embodiment, the hydrogen and oxygen are supplied to the generator or engine through a hydrogen injection system (not shown).

The hydrogen and oxygen in line 64 are passed through vacuum gauge and water trap 65, line 66, and into vacuum/pressurizer 67. Vacuum/pressurizer 67 has a vacuum portion 68 and a pressurizing portion 69. The hydrogen and oxygen pass first through vacuum portion 68, whereby a vacuum is applied to the hydrogen and oxygen. The hydrogen and oxygen then are passed to the pressurizing portion 69, wherein the hydrogen and oxygen are subjected to a pressure of from about 20 psi to about 40 psi. A portion of the pressurized hydrogen and oxygen then is passed from vacuum/pressurizer 67 through hydrogen pressure adjuster 71, line 70, check valve 72, and then into line 35. The hydrogen and oxygen in line 35 then are passed to conduit 12, wherein the hydrogen and oxygen are combined with water in line 34, whereby a magnetic field is applied to the hydrogen and oxygen, and whereby the hydrogen and oxygen and water are recycled to housing 11.

Another portion of the pressurized hydrogen and oxygen is withdrawn from the vacuum/pressurizer 67 through line 73, whereby the hydrogen and oxygen are supplied as a fuel source through, for example, a hydrogen injection system, to a generator or engine to be powered.

The invention now will be described with respect to the following examples. It is to be understood, however, that the scope of the present invention is not intended to be limited thereby.

### EXAMPLE 1

In a non-limiting example, a hydrogen reactor in accordance with the present invention was employed in order to provide hydrogen as part of the fuel to power a Cummins 250 kW generator that normally runs entirely on diesel fuel. The generator connects to an Avtron allenium load bank having a capacity of 400 kW. The load bank is a three phase load bank which can be operated at 280 volts, 480 volts, or 480 volts, and at a frequency of 60 Hz. The reactor was operated at a wattage 2.5 kW, and at a temperature of 120° F. The exhaust temperature was 700° F. The generator was run in a one hour test under a load of 225 kW, 319 amps. The engine of the generator was operated at 1,800 rpm, and at a temperature of 152° F.

The fuel consumption by the 250 kW generator was 43.1% diesel fuel and 54.9% hydrogen (H₂ or HHO) from the reactor. Emissions, in ppm, were as follows:
CO—0.00
CO₂— 6.3
NOX—0.03850
HC—0.0009

The test run consumed 7.5 gallons of diesel fuel. Normally the 250 kW generator consumes 18 gallons of diesel fuel per hour. Therefore, there was a savings of 10.5 gallons of diesel fuel. Therefore, this test run showed a major savings in diesel fuel consumption.

### EXAMPLE 2

In another non-limiting example, the hydrogen reactor of Example 1 was employed to provide hydrogen as part of the fuel to power a Cummins 250 kW generator that normally runs entirely on diesel fuel. The generator was connected to a three phase Avtron allenium load bank having a capacity of 400 kW, which can be operated at 280 volts, 480 volts, or 480 volts, and at a frequency of 60 Hz. The reactor was operated at a wattage of 2.5 kW, and at a temperature of 120° F. The hydrogen-containing exhaust entered the generator at a fuel rail injection pressure of 15 to 20 psi of hydrogen. The exhaust temperature was 700° F. The generator was run in a one hour test under a load of 225 kW, 319 amps. The engine of the generator was operated at 1,800 rpm and at a temperature of 152° F.

The hydrogen produced by the reactor was combined with diesel fuel to produce a fuel of 56% diesel and 44% hydrogen in the form of HHO. This fuel was fed to the generator at a rate of 15 cubic feet per minute and a hydrogen pressure of 40 psi. Emissions, in ppm, were as follows:
CO-0.00
CO₂— 6.3
O₂—13.2
NOX—0.03850
HC—0.0009

The fuel consumption was 5.5 gallons of diesel fuel and 42.5% hydrogen. Because the generator consumes normally 18 gallons of diesel fuel per hour, there was a savings of 12.5 gallons of diesel fuel. This example showed a major savings of diesel fuel consumption.

### EXAMPLE 3

In another non-limiting example, the hydrogen reactor of Example 1 was employed to provide hydrogen as part of the fuel to power a Cummins 250 kW generator that normally runs entirely on diesel fuel. The generator was connected to a three phase Avtron allenium load bank having a capacity of 400 kW, which can be operated at 280 volts, 480 volts, or 480 volts, and at a frequency of 60 Hz. The reactor was operated at a wattage of 1 kW and at a temperature of 120° F. The hydrogen-containing exhaust entered the generator at a fuel rail injection pressure of 15 to 20 psi of hydrogen. The exhaust temperature was 700° F. The generator was run in a one hour test under a load of 100 kW, 300 amps. The engine of the generator was operated at 1,800 rpm and a temperature of 152° F.

The hydrogen produced by the reactor was combined with diesel fuel to produce a fuel of 60% diesel and 40% hydrogen in the form of HHO. This fuel was fed to the generator at a rate of 15 cubic feet per minute and a hydrogen pressure of 40 psi. Emissions, in ppm, were as follows:
CO—0.00
CO₂— 5.4
O₂—14.5
NOX—0.0224
HC—0.0000

The fuel consumption was 4.7 gallons of diesel fuel and 40% hydrogen. Because the generator consumes normally 18 gallons of diesel fuel per hour, there was a savings of 13.3 gallons of diesel fuel. This example showed a major savings of diesel fuel consumption.

### EXAMPLE 4

In a non-limiting example, the hydrogen reactor of Example 1 was employed to provide hydrogen as part of the fuel to power a Cummins 250 kW generator that normally runs entirely on diesel fuel. The generator was connected to a three phase Avtron allenium load bank having a capacity of 400 kW, which can be operated at 280 volts, 480 volts, or 480 volts, and at a frequency of 60 Hz. The reactor was operated at a wattage of 1.5 kW, and at a temperature of 120° F. The hydrogen-containing exhaust entered the generator at a fuel rail injection pressure of 15 to 20 psi of hydrogen. The exhaust temperature was 700° F. The generator was run in a one hour test under a load of 125 kW, 250 amps. The generator was operated at 1,800 rpm and at a temperature of 152° F.

The hydrogen produced by the reactor was combined with diesel fuel to produce a fuel of 58% diesel and 42% hydrogen in the form of HHO. This fuel was fed to the generator at a rate of 15 cubic feet per minute and a hydrogen pressure of 20 psi. Emissions, in ppm, were as follows:
CO—0.00
CO₂— 5.4
O₂—14.5
NOX—0.0224
HC—0.0000

The fuel consumption was 4.6 gallons of diesel fuel and 42% hydrogen. Because the generator consumes normally 18 gallons of diesel fuel per hour, there was a savings of 13.4 gallons of diesel fuel.

### EXAMPLE 5

In a non-limiting example, the hydrogen reactor of Example 1 was employed to provide hydrogen as part of the fuel to power a Cummins 250 kW generator that normally runs entirely on diesel fuel. The generator was connected to a three phase Avtron allenium load bank having a capacity of 400 kW, which can be operated at 280 volts, 480 volts, or 480 volts, and at a frequency of 60 Hz. The reactor was operated at a wattage of 2 kW, and at a temperature of 120° F. The hydrogen-containing exhaust entered the generator at a fuel rail injection pressure of 15 to 20 psi of hydrogen. The exhaust temperature was 700° F. The generator was run in a one hour test under a load of 150 kW, 225 amps. The engine of the generator was operated at 1,800 rpm and at a temperature of 152° F.

The hydrogen produced by the reactor was combined with diesel fuel to produce a fuel of 57% diesel and 43% hydrogen in the form of HHO. This fuel was fed to the generator at a rate of 18 cubic feet per minute and a hydrogen pressure of 40 psi. Emissions, in ppm, were as follows:
CO—0.00
CO₂— 6.7
O₂—13.3
NOX—0.0352
HC—0.0000

The fuel consumption was 5.0 gallons of diesel fuel and 42% hydrogen. Because the generator consumes normally 18 gallons of diesel fuel per hour, there was a savings of 13.0 gallons of diesel fuel.

The disclosures of all patents and publications, including published patent applications, and database accession numbers, are incorporated herein by reference to the same extent as if each patent or publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A reactor for producing hydrogen, comprising:
a housing;
at least one conduit for supplying water to said housing;
at least one magnetic inductor contained in said housing, wherein said at least one magnetic inductor applies a magnetic field to said water in said housing;
at least two electrode plates contained within said housing, wherein said at least two electrode plates are capable of applying an electric charge to said water in said housing, wherein each of said at least two electrode plates, when supplied with an electric current by a source of electric current, has a positive charge or a negative charge, and wherein the number of electrode plates having a positive charge equals the number of electrode plates having a negative charge when the at least two electrode plates are supplied with an electric current by a source of electric current;
at least one conduit supplying a hot gas to said housing, and wherein, upon induction of said magnetic field by said at least one magnetic inductor to said water in said housing, upon application of an electric charge to said water in said housing, and upon heating of said water in said housing by said hot gas, hydrogen is produced from said water; and
at least one conduit for withdrawing said hydrogen from said housing.

2. The reactor of claim 1 wherein said reactor comprises at least two conduits for supplying water to said housing.

3. The reactor of claim 1 wherein said reactor comprises at least two magnetic inductors in said housing.

4. The reactor of claim 3 wherein said reactor comprises four magnetic inductors in said housing.

5. The reactor of claim 1 wherein each of said at least one magnetic inductor(s) comprises two semi-cylindrical halves, wherein each half has a longitudinal channel such that when the two semi-cylindrical halves are juxtaposed there is defined a cylinder, and wherein each semi-cylindrical half has a plurality of permanent magnets positioned therein.

6. The reactor of claim 5 wherein said cylinder formed from said juxtaposed semi cylindrical halves is capable of receiving a water conduit, and wherein said cylinder forms an annular ring permanent magnet.

7. The reactor of claim 1 wherein said at least two electrode plates are operated at a wattage of about 2,500 watts.

8. The reactor of claim 1, and further comprising at least one pump connected operatively to said at least one conduit for supplying said water to said housing, whereby said water is delivered from said conduit into said housing.

9. A method of producing hydrogen from water, comprising:
introducing said water into a reactor;
applying a magnetic field to said water in said reactor;
applying a positive electric charge and a negative electric charge to said water in said reactor;
introducing a hot gas into said reactor, thereby heating said water in said reactor, and wherein, upon applying said magnetic field to said water in said reactor, upon applying said positive and negative electric charges to said water in said reactor, and upon heating of said water in said reactor by said hot gas, hydrogen is produced from said water; and
recovering hydrogen from said reactor.

10. The method of claim 9 wherein said magnetic field is applied to said water at a strength of about 13,000 Gauss.

11. The method of claim 9 wherein said positive electric charge and said negative electric charge are applied at a wattage of about 2,500 watts.

12. The method of claim 9 wherein said water is heated by said hot gas to a temperature of from about 50° F. to about 400° F.

13. The method of claim 12 wherein said water is heated by said hot gas to a temperature of about 120° F.
